(19) United States
(12) Patent Application Publication
(10) Pub. No.: US 2016/0018969 A1
(43) Pub. Date: Jan. 21, 2016

(54) METHOD AND APPARATUS FOR CONTEXTUAL NOTIFICATIONS AND USER INTERFACE

(71) Applicant: Verizon Patent and Licensing Inc., Arlington, VA (US)

(72) Inventors: Ramya SUNDARRAMAN, Chennai (IN); Rajasundaram GANESAN, Chennai (IN); Vijayan RADHAKRISHNAN, Chennai (IN); Prabhu V. MOHAN, Chennai (IN); Sridevi RAJENDRAN, Chennai (IN); Vijay A. SENTHIL, Chennai (IN); Anand CHANDRASEKAR, Chennai (IN); Vinodkrishnan SURIANARAYANAN, Chennai (IN); Parthasarathi KATHIRESAN, Chennai (IN)

(21) Appl. No.: 14/336,807

(22) Filed: Jul. 21, 2014

(51) Int. Cl. G06F 3/0484; G01C 21/36; H04L 29/08

(52) U.S. Cl. CPC G06F 3/04842; H04L 67/18; G01C 21/36

(57) ABSTRACT

An approach is provided for determining and providing contextual notifications and user interface. The approach includes presenting a user interface, wherein the user interface presents an origin point, a destination point, or a combination thereof associated with a user. The approach also includes receiving an input via the user interface for specifying a notification point. Additionally, the approach includes generating a location-based notification based on the notification point, wherein the location-based notification is triggered when the user is within a predetermined proximity of the notification point.

### BACKGROUND INFORMATION

With technological advances in available user devices and applications, various applications and service providers can provide useful and efficient functionalities at the devices. Additionally, many users utilize a variety of the devices, applications, or services to perform various tasks throughout the day. For example, a user device (e.g., a mobile phone, tablet, laptop computer, etc.) and relevant applications may be utilized to access services for navigation, organizing/synchronizing tasks, entertainment, online shopping, content consumption, business transactions, or the like. One area of interest to users is utilizing the applications and services at a device for monitoring various tasks, events, or information associated with the user and providing notifications or additional information about the tasks, events, or the information. However, current applications or services are not able to efficiently and accurately monitor, collect, or process large amounts of potential data for providing notifications or information to the users.

Based on the foregoing, there is a need for determining and providing contextual notifications and user interface at a user device.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of determining and providing contextual notifications and user interface, according to one embodiment;

FIG. 2 is a diagram of the components of a notification platform, according to one embodiment;

FIG. 3 is a diagram of the components of a user device, according to one embodiment;

FIGS. 4 through 7 are flowcharts of processes for determining and providing contextual notifications and user interface, according to various embodiments;

FIGS. 8A through 8D are diagrams of user interfaces for use in the processes of FIGS. 4 through 7, according to various embodiments;

FIG. 9 is a diagram of a computer system that can be used to implement various exemplary embodiments; and

FIG. 10 is a diagram of a chip set that can be used to implement an embodiment of the invention.

### DESCRIPTION OF THE PREFERRED EMBODIMENT

An apparatus, method and software for determining and providing contextual notifications and user interface (UI) are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described for determining and providing contextual notifications and associated UI at a user device (e.g., mobile phone, tablet, etc.), it is contemplated that these embodiments have applicability to a variety of user devices, applications, or services where various tasks, conditions, events, or contextual information may be monitored for determining and presenting one or more notifications and associated UI elements at a user device.

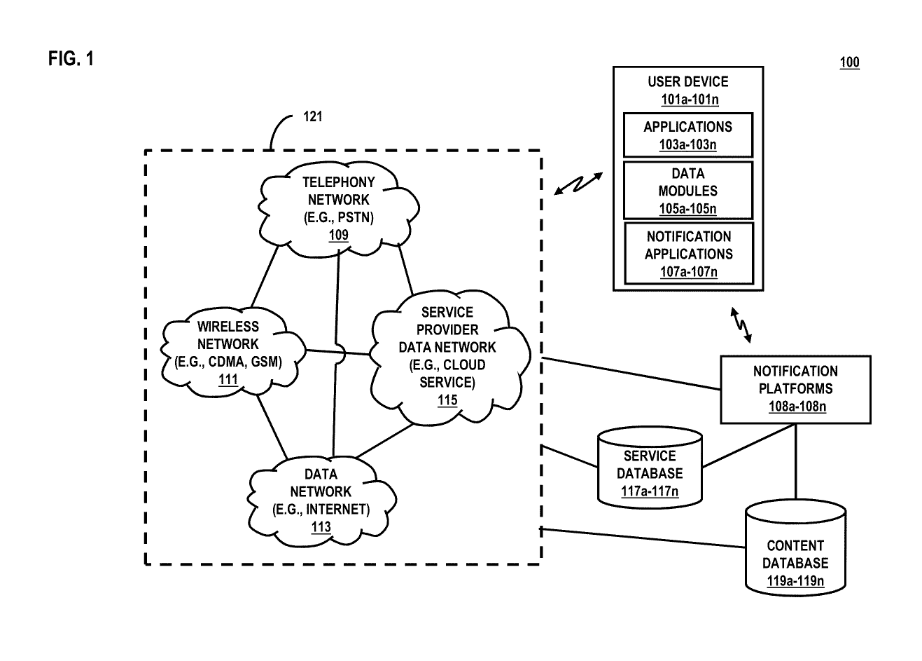

FIG. 1 is a diagram of a system for determining and providing contextual notifications and associated UI at a user device. As people/users may become busy with a variety of tasks at different venues, they may not be aware of or be able to track different events or information associated with a task, an upcoming task, or their environment. For example, while a user is conducting a meeting at his office, he may not remember that there is a scheduled conference call in a few minutes. Therefore, most users utilize one or more applications or services at a user device to track tasks associated with the users and provide timely notifications. In one scenario, a user may utilize a calendar application at a user device to track his daily or weekly schedule and provide notifications about tasks or events in the schedule. In some instances, the notifications may be simply based on a time parameter (e.g., defined by the user) where a reminder notification for an upcoming task/event may be determined or generated based on the time of the task/event. For example, a calendar application may generate a notification about an upcoming dental appointment. In some situations, a user may be unaware of events or information associated with his surroundings where the user may be busy, inattentive, sleeping, etc.; however, the user may very well desire or need to become aware of the events or the information. For example, a user travelling to a destination point may need/wish to be notified when nearing the destination point, or when there is a deviation from a travel route to the destination point, or when there are unexpected events/activities associated with the travel route, with the destination point, with a service along the travel route or at the destination point, or the like. Therefore, there is a need for determining and providing contextual notifications and associated UI at a user device.

To address these issues, system 100 of FIG. 1 provides the capability for determining and providing contextual notifications and associated UI at a user device, according to one embodiment. Generally, a user may utilize various functionalities of a user device, applications at the user device, or services for receiving notifications associated with one or more tasks or events of interest to the user. For instance, most applications and services provide the notifications based on simple parameters defined by the user, the applications, or the services. Also, as there may be occasions when the user may not be fully aware of his surroundings (e.g., sleeping, busy with other tasks, etc.), the user may wish to utilize an application or a service that can process contextual information associated with the user, his tasks, his surroundings, or the like for providing contextual notifications and various UI elements at a user device.

In one use case, a traveler may wish to remain undisturbed (e.g., by an attendant), unconcerned about missing his destination point (e.g., a target train/bus stop) or having enough time to prepare for arrival at the destination point (e.g., gather belongings), as the traveler may be sleeping or preoccupied with other tasks (e.g., playing a game, watching a movie, listening to a lecture, etc.)

In one scenario, a user beginning a travel or a movement from an origin geo-location to a destination geo-location may utilize an application at a user device or a service platform to initiate a process for determining a suitable geo-location (e.g., prior to reaching the destination point) along the route where one or more notifications may be generated and presented at the user device. For example, a user beginning a travel from a point “A” to a point “B” may wish to have a notification at a point “C” along the route, which would be prior to reaching the destination point “B”. In one embodiment, the system 100 may present a UI at a user device associated with a user for presenting, verifying, or receiving information about travel plans associated with the user, wherein the system 100 can determine and provide a contextual notification at the user device. In various examples, the contextual notification may be based, at least in part, on the travel plans, a user profile, user preferences, user selections of one or more options presented via the UI, processing of or determining contextual information along the travel route, or the like.

In one embodiment, the system 100 may substantially automatically determine one or more information items associated with travel plans of a user. For example, the information items may be determined from one or more applications (e.g., calendar, text messaging, chat sessions, emails, etc.) at a user device. In one embodiment, the system 100 may determine a beginning of a potential travel by a user based on the user location information, wherein a UI may be presented at a user device so that the user may interact with the system 100 for verification, selection, or inputting of various information or options via the UI. For example, a user may be presented with the UI if the user location information indicates that the user is at a train station, at a bus station, at an airport, at a truck stop, or the like.

In various scenarios, a travel or a movement by a user may be along a short route, a long distance route, on a campus with several POIs, or the like, wherein the user may or may not be aware of his surroundings during some of the travel route. For example, a user travelling on a train from one city to another may be sleeping some of the time during the travel. In one example, a user may be driving a vehicle for travelling from one POI to another POI. In another example, a user may be transporting himself from one location to another location in a hospital building/campus, wherein one or more notifications may be generated and presented at a user device associated with the user or at one or more other user devices of other users.

For the purpose of illustration, the system 100 may include one or more user devices 101a-101n (user device 101), which may include, execute, and utilize one or more applications 103a-103n (also referred to as applications 103), one or more data collection modules 105a-105n (also referred to as Data module 105), and notification applications 107a-107n (also referred to as notification application 107 or a notification application.) In various embodiments, a notification application 107 may be an independent application or widget which may be included in a user device by a manufacturer of the user device, or it may be downloaded by a user of the user device. Additionally, the notification application 107 may be independent of an operating system of a user device or it may be implemented based on the operating system at a user device.

Furthermore, the system 100 may include a network system 121, which may include one or more networks, including a telephony network 109, a wireless network 111, a data network 113, a service provider data network 115, etc. By way of example, the networks 109, 111, 113, and 115 may be any suitable wireline and/or wireless network, which may be managed by one or more service providers. In one example, the networks 109, 111, 113, and 115 may be one or more elements in a network system 121, which may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network. By way of example, a service provider 115 may provide any number of services (e.g., mapping services, social networking services, media services, content services, etc.) via a web server or other means of communications (e.g., text messaging, voice, instant messaging, chat, etc.)

Additionally, the system 100 may include one or more notification platforms 108a-108n (also referred to as a notification platform 108 or a notification platform), which may implemented as a remote or a local platform. For example, a remote notification platform may be implemented as a standalone or as an integrated component of a service or a content provider in the network system 121. In one example, a notification platform may be implemented by a local service provider (e.g., a train station, a hospital, etc.), which may be utilized to provide information on services offered by the local service provider, one or more information items that may be utilized in determining and providing contextual notifications and UI at a user device 101. In one embodiment, a local notification platform may be implemented in conjunction with a remote notification platform for combining and presenting information available from a remote service provider and a local service provider. Further, a notification platform may include or utilize a notification application, which may include all or some of the functionalities of a notification application of a user device 101.

Although depicted as separate entities, the networks 109, 111, 113, and 115, and the notification platform 108 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

In one embodiment, a service provider 115 may include or have access to one or more service databases 117a-117n (also collectively referred to as a service database 117), which may include various user information, user profiles, user preferences, one or more profiles of one or more user devices (e.g., device configuration, sensors information, etc.), service providers 115 information, other service providers' information, and the like. In one embodiment, the service provider 115 may include one or more service providers offering one or more services, for example, navigation services, travel services, online shopping, social networking services (e.g., blogging), content sharing, media upload, media download, media streaming, account management services, or a combination thereof.

In one embodiment, the service provider 115 may include and/or have access to one or more content databases 119a-119n (also collectively referred to as a content database 119), which may store, include, or have access to various content items. For example, the service provider 115 may store content items (e.g., at the content database 119) provided by various users, various service providers, crowd-sourced content, or the like. Further, the service provider 115 a content provider may utilize one or more service application programming interfaces (APIs)/integrated interface, through which communication, notifications, updates, content, and information (e.g., associated with users, applications, services, content, etc.) may be shared, accessed or processed.

By way of examples, the user devices 101 may communicate with other devices via one or more proximity-based communication channels or via one or more network service providers in the network system 121. Further, the applications 103 may include various applications for productivity, education, entertainment, social networking, web browser, communications, content sharing, multimedia applications, UI, map application, web client, or the like.

In one embodiment, a user device 101 may utilize a Data module 105 for determining/collecting data or content associated with the user device 101, one or more users of the user device 101, the applications 103, environment/surroundings of the user device, and the like. In addition, the user device 101 can execute an application 103 that is a software client for storing, processing, and/or forwarding one or more information items to other components of the system 100. In various embodiments, the Data module 105 may include various sensors for detecting and capturing various signals, information, and contents, for example, audio, video, location information, Bluetooth signals, near field communication (NFC) signals, wireless local area network (WLAN) signals, RFID signals, or the like. Further, the collected information, content, or signals may be shared, via the applications 103 and/or the notification application 107, with a notification platform, other user devices 101, or service providers in the network system 121.

It is noted that user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone, set-top box, TV set, or any combination thereof. It is also contemplated that the user devices 101 can support any type of interface for supporting the presentment or exchanging of data. In addition, user devices 101 may facilitate various input means for receiving and generating information, including touch screen capability, keyboard and keypad data entry, voice-based input mechanisms and the like. Any known and future implementations of user devices 101 are applicable. In certain embodiments, user devices 101 may be configured to establish peer-to-peer communication sessions with each other using a variety of technologies, including near field communication (NFC), Bluetooth, ZigBee, infrared, etc. Also, connectivity can be provided via a wireless local area network (LAN). By way of example, a group of user devices 101 may be configured to a common LAN so that each device can be uniquely identified via any suitable network addressing scheme.

In various embodiments, the user devices 101 may communicate with one or more components of the system 100 (e.g., a service provider, another user device, etc.) via one or more proximity-based communication methods and protocols. For example, the communication may be via Bluetooth®, a wireless local area network (WLAN), or other available communication methods. In various examples, the notification application 107 may communicate with one or more networks and service providers of the network system 121 or the notification platform 108 to provide information and/or request information or services. In various scenarios, a notification application 107 on a user device 101 may request or utilize information from the applications 103 or the Data module 105 to determine status information associated with one or more processes, applications, notifications, content items, UI presentation options, available options, available functionalities, user profile, user preferences, user configuration, device configuration, or the like.

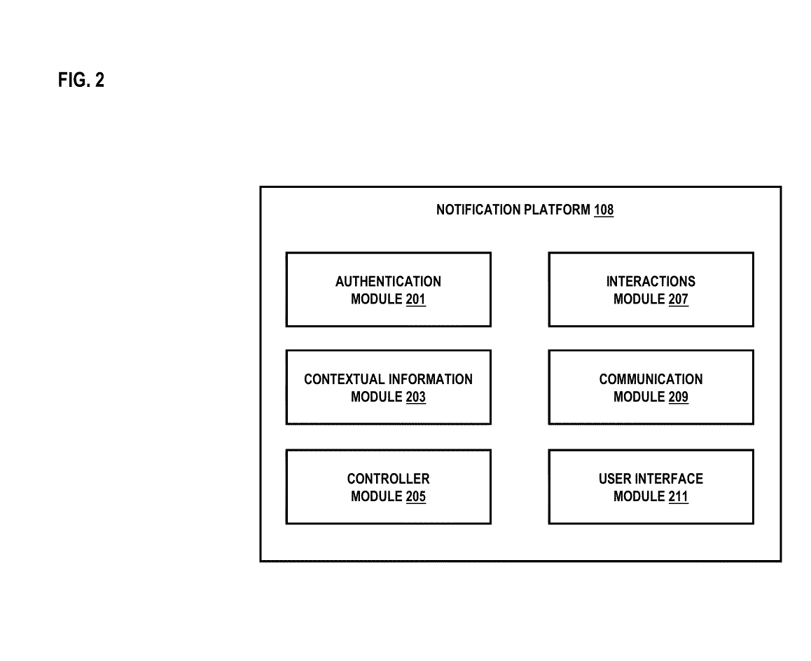

FIG. 2 is a diagram of the components of a notification platform, according to one embodiment. The notification platform 108 includes various executable modules for performing one or more computing, data processing and network based instructions that in combination provide a means of engaging user interactions for determining and providing contextual notifications and user interface at a user device. Such modules can be implemented in hardware, firmware, software, or a combination thereof. By way of example, the notification platform 108 may include an authentication module 201, a contextual information module 203, a controller module 205, an interactions module 207, a communication module 209, and a user interface module 211. In addition, the notification platform 108 may include or have access to one or more databases (e.g., databases 117, 119, or the like.)

In one embodiment, an authentication module 201 may authenticate users or user devices 101 for interaction with the notification platform 108. By way of example, the authentication module 201 may receive a request from a user of a device 101 to subscribe to the notification platform 108 service for determining and providing contextual notifications and user interface at the user device. The authentication process may include enabling discovery of and communication between the user device 101 and a notification platform 108. Other settings may include specifying a method for communicating notifications and related information to the user device 101 via a short messaging service (SMS), a web-based communication, or the like. Additionally, various capabilities of the user device 101 may be determined, for example, in relation to media content presentation, user interface, processing power, or the like. In certain instances, the initial authentication process may also involve the uploading of the notification application 107 onto the user device 101. The authentication process may also include receiving and validating a login name or a user identification value as provided or established for a particular user during a subscription or registration process with one or more service providers. The login name or user identification value may be received as input provided by the user from the user device 101. Alternatively, the login process may be performed through automated association of user profile settings maintained by the notification platform 108, or one or more other service/content providers. By way of example, the authentication module 201 may utilize one or more validated user information items to initiate one or more interactions with one or more other service providers associated with one or more user accounts at, for example, a navigation service, a travel service, a bank, a communication service provider, or the like.

In one embodiment, the contextual information module 203 may operate in connection with the user interface module 211 and the controller module 205 to enable receiving or processing information for determining contextual information associated with a user, a user device, user activity, user/device environment, or the like. By way of example, the contextual information module 203 may determine information about a user's travel plans, an actual or a potential travel route, POIs along a travel route, a notification point along a travel route, or the like. In one embodiment, the contextual information module 203 may receive or retrieve one or more information items from a service provider, a transportation carrier, the applications 103 at the user device 101, or the like.

In one embodiment, a controller module 205 is configured to operate and effectuate the processes by or at other modules of the notification platform 108. For example, the controller module 205 may generate the appropriate signals to control the communication module 209 and the contextual information module 203 for facilitating a transmission of the information over the network system 121.

In one embodiment, the interactions module 207 may operate in conjunction with the contextual information module 203 and the controller module 205 to determine and present one or more options for a user to interact with a travel route, a movement path, a notification point, a notification alert/message, or the like. In various examples, the options may include a response indicative of a user selection of a notification point, a notification option, a travel route modification, or the like. For example, in response to an indication of interest by the user in a recommended notification point, the interactions module 207 may cause a presentation of a graphical UI for listing further details regarding the notification point. As another example, in response to a request for selecting a notification point, the user may be presented with one or more prompts for initiating and/or concluding a notification alert or message. In one embodiment, the interactions module 207 may also interact with the authentication module 201 and controller module 205 for the settings and preferences of a user account or a user profile.

In one embodiment, the communication module 209 may be utilized to communicate with various applications, modules, or components at a user device 101 or at a notification platform 108 for presenting information, options, messages, or the like associated with a notification or a service. Additionally, the communication module 209 may be utilized to communicate with one or more components of the system 100. In one scenario, the communication may be effectuated via a communication module available at the user device 101. In one embodiment, the communication module 209 may utilize one or more communication channels to communicate one or more notification messages, command messages, inquiry messages, or the like. By way of example, the communication module 209 executes various protocols and data sharing techniques for enabling collaborative execution between a user device 101 and the notification platform 108.

In one embodiment, the UI module 211 may cause a rendering or presentation of a UI including various information and options associated with processes, applications, notifications, services, contents, or the like. In one example, the presentation may include visual effects on the presented options. In various scenarios, the presentation may include one or more augmented reality (AR) or virtual reality (VR) elements, which may provide additional visual effects for a better, more effective, or user friendly experience. In one embodiment, the UI module 211 may cause a presentation of a UI at a user device so that a user may interact with one or more elements present in a notification message or with a notification alert. In one embodiment, the UI module 211 may provide various options for a user to select, highlight, or float over one or more options, information items, or the like at a user device 101. In one embodiment, the UI elements may be determined based on contextual information associated with a user, a user device, a notification alert/message, or the like that may be presented at the user device 101. By way of example, the user interface module 211 may cause a generation of a UI at a user device 101 in response to application programming interfaces (APIs) or other function calls corresponding to a service provider for enabling display of graphical or textual elements to enable receiving or viewing of various notification and information items included therein.

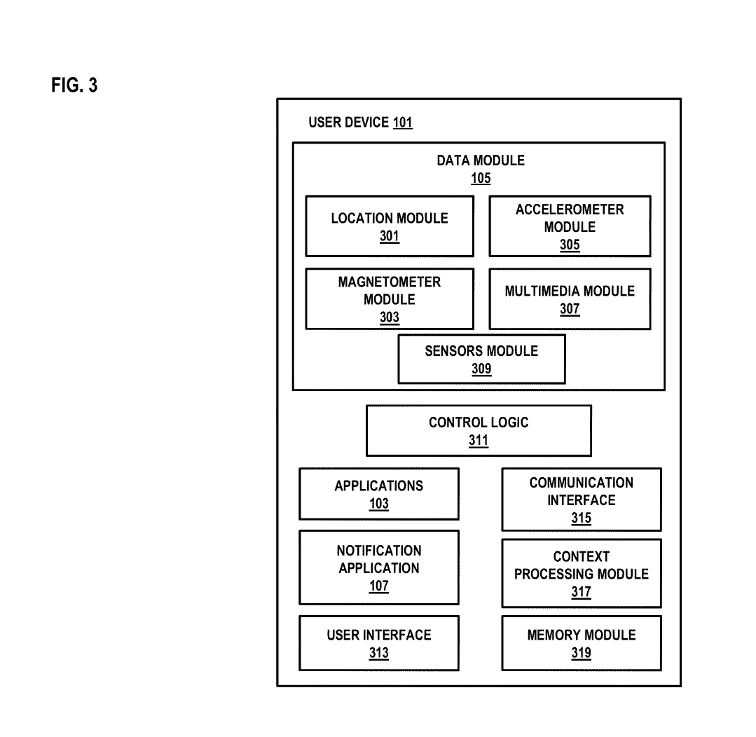

FIG. 3 is a diagram of the components of a user device, according to one embodiment. By way of example, a user device 101 includes one or more components for executing various applications, enabling various functionalities, and for communicating with other user devices 101 or with other components of the system 100. It is contemplated that the functions of these components may be combined in one or more components or performed by other components of equivalent functionality. In one embodiment, the user device 101 includes a Data module 105, which may include one or more location modules 301, magnetometer modules 303, accelerometer modules 305, multimedia module 307, and sensors module 309. Further, the user device 101 may also include control logic 311 to coordinate the use of other components of the user device 101, a user interface 313, a communication interface 315, a context processing module 317, and a memory module 319. The applications 103 and the notification application 107 may execute on the control logic 311 utilizing the components of the user device 101. In various embodiments, the notification application 107 may operate in conjunction with the applications 103 and/or with one or more modules at a user device 101 for determining and providing contextual notifications and related UI elements at a user device. In one embodiment, a notification application 107 may operate in connection with the user interface 313 and the control logic 311 to enable presentation of notifications, one or more information items, or the like that may be included in a presentation of notifications at the user device 101.

The location module 301 can determine a user's location, for example, via location of a user device 101. The user's location can be determined by a triangulation system such as GPS, assisted GPS (A-GPS), Cell of Origin, or other location extrapolation technologies. Standard GPS and A-GPS systems can use satellites to pinpoint the location of a user device 101. A Cell of Origin system can be used to determine the cellular tower that a cellular user device 101 is synchronized with. This information provides a coarse location of the user device 101 because the cellular tower can have a unique cellular identifier (cell-ID) that can be geographically mapped. The location module 301 may also utilize multiple technologies to detect the location of the user device 101. Location coordinates (e.g., GPS coordinates) can give finer detail as to the location of the user device 101 when media is captured. In one embodiment, GPS coordinates are stored as context information in the memory module 319 and are available to the context processing module 317, the Data module 105, and/or to other entities of the system 100 (e.g., via the communication interface 315.) Moreover, in certain embodiments, the GPS coordinates can include an altitude to provide a height. In other embodiments, the altitude can be determined using another type of altimeter. In one embodiment, the notification application 107 may utilize the location information of the user device for determining an origination point, a destination point, a notification point, or the like in reference to a travel route or a movement path associated with the user. For example, location information of the user device may be utilized to present, in a UI at the user device, a travel route from an origin point to a destination point and one or more suggested notification points where one or more notifications may be presented at the user device. In one embodiment, the notification application 107 may utilize a plurality of location data points to determine moving speed of a vehicle/carrier that the user/user device may be travelling on, but if the moving speed is outside of a normal range (e.g., normal speed limit), a notification may be presented at the user device.

The magnetometer module 303 can be used in finding horizontal orientation of the user device 101. A magnetometer is an instrument that can measure the strength and/or direction of a magnetic field. Using the same approach as a compass, the magnetometer is capable of determining the direction of a user device 101 using the magnetic field of the Earth. The front of a media capture device (e.g., a camera) can be marked as a reference point in determining direction. Thus, if the magnetic field points north compared to the reference point, then the angle of the user device 101 from the magnetic field is known. Simple calculations can be made to determine the direction of the user device 101. In one embodiment, horizontal directional data obtained from a magnetometer can be stored in memory module 319, made available to other modules and/or applications 103 of the user device 101, and/or transmitted via the communication interface 315 to one or more entities of the system 100. In one embodiment, the notification application 107 may utilize the directional data and the location information to determine a deviation from a travel route. For example, the directional data may indicate that the user/user device is moving in a different direction when compared to a travel route direction.

The accelerometer module 305 can be used to determine vertical orientation of the user device 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a user device 101 is stationary, the accelerometer module 305 can determine the angle the user device 101 is pointed as compared to Earth's gravity. In certain embodiments, the magnetometer module 303 and accelerometer module 305 can be means for ascertaining a perspective of a user. This perspective information may be stored in the memory module 319, made available to other modules and/or applications 103 of the user device 101, and/or sent to one or more entities of the system 100.

In one embodiment, the multimedia module 307 may be utilized to generate, receive, or consume, etc. various content/media items, for example, images, video, audio, text, and the like. In various embodiments, the media items may be shared with the applications 103 or the notification application 107, which in turn may share the media with one or more components of the system 100. In various embodiments, the multimedia module 307 may interface with various sensors; for example, a camera, a microphone, etc., to determine additional contextual information associated with a media item, a code associated with a notification or a content item, and the like.

In various embodiments, the sensors module 309 can process sensor data from various sensors (e.g., microphone, optical, Bluetooth, NFC, GPS, accelerometer, gyroscope, thermometer, etc.) to determine environmental (e.g., atmospheric) conditions surrounding the user device 101, user mood, location information, and various other information from a range sensors that may be available on one or more devices. For example, the sensors module 309 may detect conditions including humidity, temperature, geo-location, biometric data of the user, etc. Once again, this information can be stored in the memory module 319 and sent to the context processing module 317 and/or to other entities of the system 100. In certain embodiments, information collected from the Data module 105 can be retrieved by the control logic 311 and stored at the memory module 319, made available to other modules and/or applications 103 of the user device 101, and/or sent to one or more entities of the system 100. In various embodiments, an audio sensor, an optical sensor, or a motion sensor may be utilized to capture and process various sensor data associated with an environment of the user/user device. For example, sensor data captured in or near a cabin of a train, which is occupied by a user and other passengers, may be indicative of present sounds, images, or motions that may be produced by the passengers, by other people, by nearby equipment, or the like. In one scenario, a temperature sensor on a user device in a truck/bus/train may notify the driver or the passengers that the temperature is below or above a certain level.

The user interface 313 can include various methods for a user to interface with applications, modules, sensors, and the like at a user device 101. For example, the user interface 313 can have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, etc. In one embodiment, the user interface 313 may interact with the notification application 107 for determining and presenting a UI and applicable options based on a notification or user interactions with a notification. In one embodiment, the UI 313 may interact with the notification application 107 in order to effectuate a presentation of one or more notifications, interaction indicators, interaction options, command messages, or the like at the user device 101.

In one embodiment, the UI 313 may cause a rendering or presentation of a UI including various information, elements, or options associated with processes, notifications, applications, or the like. In one example, the presentation may include visual effects on the presented information, elements, or options. In various scenarios, the presentation may include one or more AR or VR elements, which may provide additional visual effects for a better, more effective, or user friendly experience. In one embodiment, the UI 313 may cause a presentation of a UI at a user device so that a user may interact with one or more elements present in a notification, or the like. By way of example, the user interface 313 may generate a UI in response to application programming interface (API) or other function calls corresponding to a service provider, the notification application 107, or the like for enabling display of graphical and textual elements. Additionally, the UI elements may be generated at the user device 101 to enable viewing of various notification and information items included therein.

In one embodiment, the communication interface 315 can be used to communicate with one or more entities of the system 100, for example, to submit a request for and receive a content stream from various content stream providers. In various embodiments, the communication interface 315 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the network system 121). In some examples, the user device 101 can send context information associated with the user device 101 to other user devices 101 and/or to other entities of the system 100.

The context processing module 317 may be executing on the control logic 311 for determining context information available from the Data module 105, the applications 103, or from the notification application 107. This information may be transmitted, via the communication interface 315, to one or more user devices 101 and/or to other entities of the system 100. The context processing module 317 may additionally be utilized as a means for determining information related to the user, an instance of data, a value, a process, a content item, an object, a subject, that an application 103 is being executed, or the like. In certain embodiments, the context processing module 317 can infer higher level context information from the context data such as activity at a user device 101, user information, information about an environment of the user/user device, etc. In one example, contextual information associated with a user/user device may be processed or utilized to determine and provide contextual notifications and user interface at a user device.

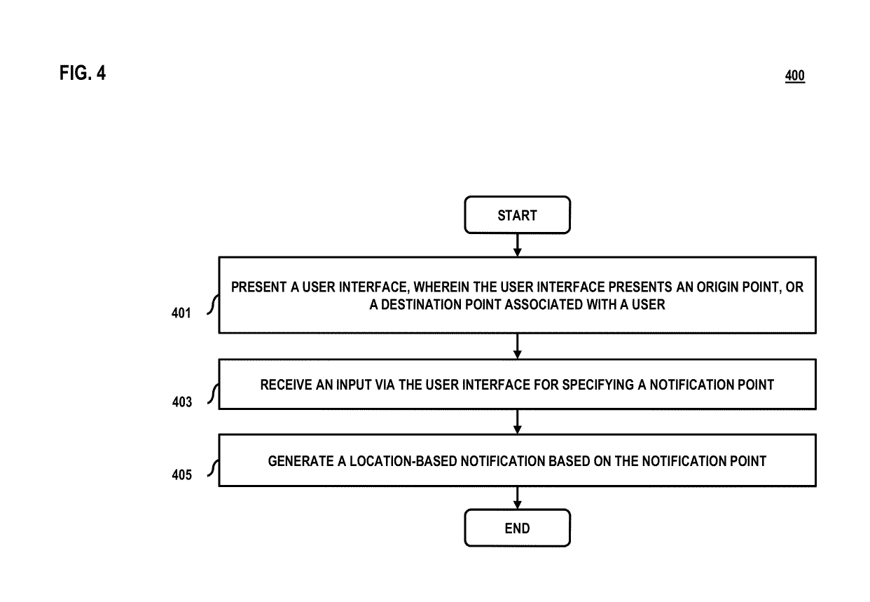

FIGS. 4 through 7 are flowcharts of processes for determining and providing contextual notifications and user interface, according to various embodiments. It is noted that the steps of processes 400, 500, 600, and 700 may be performed in any suitable order as well as combined or separated in any suitable manner. Further, all or portions of the steps or the processes may be initiated or completed by any of the components of the system 100, for example, by a notification application 107 or a notification platform 108. However, for clarity in discussing the processes, the notification platform 108 is referred to as completing various steps of said processes, which may be performed in any suitable order and one or more of the steps may be optional.

As shown in FIG. 4, the process 400 may begin at step 401 where the notification platform may cause a presentation of a user interface at a user device, wherein the user interface presents an origin point, a destination point, or a combination thereof associated with a user. In one embodiment, one or more applications at a user device 101 may determine information that a user is in the process of starting a movement/travel from an origin point (e.g., home, train station, airport, a particular location in a building/campus, etc.) to a destination point (e.g., another city/town, another location in the same city, town, building, campus, or the like). In various scenarios, the information may be determined from one or more applications at the user device 101, a service provider, one or more other user devices 101 associated with the user, or the like. In one example, a calendar application at the user device 101 may include an entry about a travel plan of a user where the calendar application may provide information about the travel plan to the notification platform, wherein the information may be provided in advance of the travel, or close to the planned travel time, or when the user location is near the origin point (e.g., at the train station) at the time when the travelling is to begin, or the like. In one example, the travel information may be provided by a service provider, which may have knowledge of a travel itinerary associated with the user. In one example, a user of the user device 101 may initiate an interaction with one or more applications at the user device 101 to indicate that the user is beginning the travel/movement from the origin point. In one embodiment, the notification platform may process the travel/movement information and cause a presentation of one or more UI elements at the user device indicative of a travel plan from the origin point to the destination point. For example, the UI may present a map application including indicators and information about a travel/movement route from an origin point to a destination point. In one scenario, a travel/movement may be over a short distance from an origin point to a nearby destination point. For example, a user movement may be from one point to another point on a school campus, a hospital building/campus, a factory campus, a resort property, or the like. In one embodiment, the notification platform may cause a presentation of one or more options at a UI of a user device 101 so a user may interact with the travel/movement information or route presented at the user device 101. For example, the UI may present on a map application a travel route from City A to City B, wherein the user may select from one or more options for confirming, cancelling, editing, updating, or the like, the presented travel route information. In various embodiments, one or more applications at a user device 101 may utilize AR, VR, or the like for presenting information or elements of a UI at the user device 101.

In one embodiment, the UI may include a first section or area to configure one or more parameters for a travel route, wherein the first section includes one or more options for selecting a source of information for the travel route. In various scenarios, the first section may include UI elements associated with a travel notification application where one or more prompts may be presented to a user of the user device 101 so the user may input or select from various options for providing information about a travel plan/route, or to provide a source for that information. In various examples, a user may select from one or more options to indicate that the source of travel information may be an application 103 (e.g., a calendar), input by the user, user's prior travel history information, or the like.

In one embodiment, the UI may include a second section to configure one or more parameters for the location-based notification, wherein the second section includes one or more options for selecting the notification point. For example, the second section may include a presentation of a prompt which a user may interact with to select from various options associated with a notification. In one scenario, the user may confirm a request for a notification via a notification configuration prompt and then further interact with the notification configuration prompt to select an option for the notification application to recommend a notification point, or an option for the notification application to receive information via a user input, or to select an option so that a notification for a current or an upcoming travel plans should be same as a last trip of the user.

In one embodiment, the user interface may include a third section to configure one or more options for including one or more information items in a presentation of the location-based notification. For instance, the third section may include one or more options for presenting information about an estimated time of arrival that may be related to an arrival time at a notification point, at a destination point, at one or more other POIs along a travel route, or the like. Further, the third section may present options for determining or presenting information about available services at a notification point, at a destination point, at one or more other POIs along a travel route, or the like.

In various embodiments, the notification platform, a service provider, a content provider, applications at a user device, or the like may dynamically determine various UI sections, segments, areas, layers, levels, or the like, wherein various UI options, elements, indicators, or the like may be presented for user interaction. Potential UI features that may be presented at or via a user device are not limited to examples, embodiments, scenarios, or use cases presented or discussed herein.

At step 403, the notification platform may receive an input via the user interface for specifying a notification point. In one embodiment, one or more applications at the user device 101 may determine a selection/input by a user of the user device 101, wherein the selection/input may be in response to one or more options for determining or selecting a location (e.g., a geo-location, a location at a POI, etc.) where a notification can be presented at the user device 101. For example, a user may select a UI option to confirm, start, edit, or the like, a geo-location point on a travel route from an origin point to a destination point. In one example, a user travelling from a POI “A” to a POI “B” may be presented with one or more options for selecting from one or more other POIs “C”, “D”, etc., where one or more notifications may generated and presented at the user device 101. In one embodiment, a notification platform may receive an input from a user device for specifying or selecting a certain POI (e.g., a train station, a town, etc.) as a notification point along a travel route or a movement path, whereat the notification platform or a service provider is to generate or cause a notification at the user device.

At step 405, the notification platform may generate a location-based notification based on the notification point, wherein the location-based notification is triggered when the user device is within a predetermined proximity of the notification point. In one embodiment, a notification platform may utilize location information of a user from one or more sources (e.g., a service provider, a location sensor on a user device 101, etc.) to determine proximity to location of a notification point. Further, the notification platform may generate one or more notifications at a user device, wherein the notifications may include one or more visual, audible, tactile, textual, or the like elements. For example, a notification may be generated at a location that is 10 miles before reaching a destination point of the user. In various examples, a notification point may be at a certain POI, or at a POI that is a certain number of stations/stops before reaching the destination point, or the like.

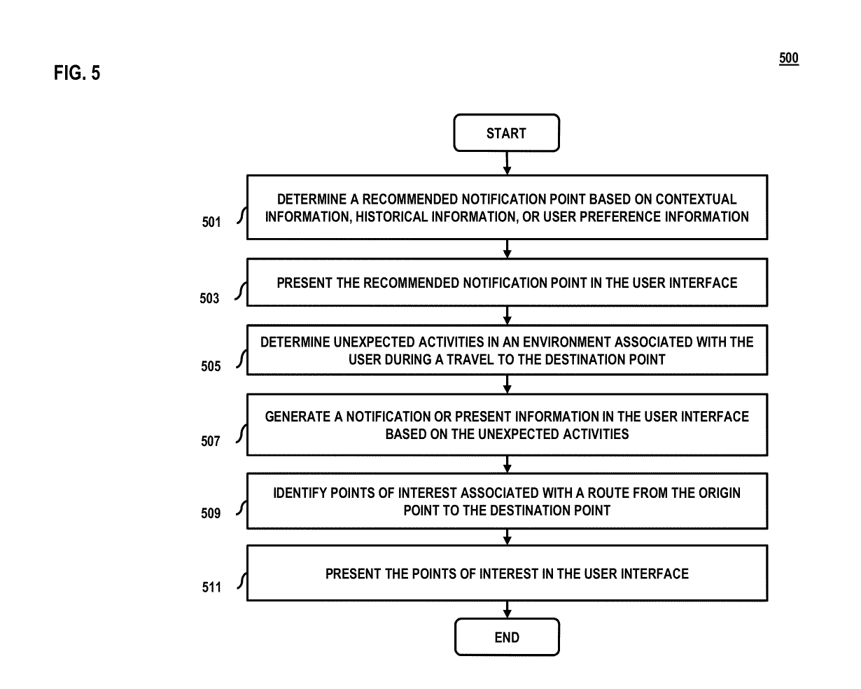

Referring to FIG. 5 now, the process 500 may begin at step 501 where the notification platform may determine a recommended notification point based on contextual information, historical information, user preference information, or a combination thereof. In one embodiment, the contextual information may be determined based on a travel route (e.g., scenic route, shortest route, etc.), a mode of travel (e.g., train, bus, car, airplane, boat, etc.) purpose of travel (e.g., urgent, business, leisure, etc.), number of other travelers or luggage items associated with the user, or the like. For example, a notification point closer to the destination point of the user may be recommended if it is determined that the user is travelling alone and has only one luggage item (e.g., a briefcase), since the user may not need very much time to prepare for disembarking from the travel vehicle. In one example, an earlier notification point may be recommended to a user who may need assistance with preparing for disembarking. In another example, an earlier notification point may be recommended to a user who is not familiar with the area of the destination point. In various scenarios, the historical information may be determined based on prior travel information associated with the user, the user device, a current travel route, a mode of travel, the origin or destination points, a travel service provider, time of travel (e.g., day, month, season, etc.), duration of travel (e.g., short, long, hours, days, etc.), or the like. In various scenarios, the user preference information may be determined based on user profile at a user device 101, a user travel profile, a user travel itinerary, a user account at a travel service provider, or the like.

At step 503, the notification platform may cause a presentation of the recommended notification point in the user interface. In various embodiments, one or more applications at a user device 101 may cause a presentation of a recommended notification point via one or more UI elements at a user device 101. In various examples, the UI elements may include graphical representations, textual information, geo-location information, distance information, POIs or services associated with the recommended notification point, or the like. Further, the recommended notification point may be presented in terms of time or distance and referenced to the origination point, to the destination point, to another POI, or the like. In various embodiments, the UI may include AR or VR elements which a user may interact with for determining additional information, options, selections, or the like.

At step 505, the notification platform may determine one or more unexpected activities in an environment associated with the user during a travel to the destination point. In one embodiment, information from one or more sensors at a user device 101 may be utilized to determine one or more activities, one or more events, or the like which may be unexpected or unusual in the environment of a user/user device while on a travel route to a destination point. In one scenario, a user travelling on an airplane/train/bus may be sleeping or may be listening to music while wearing a sleep mask, wherein most other passengers are also in a state of calm (e.g., sleeping, watching television, etc.) In one scenario, audio, optical, or motion sensors on a user device 101 may monitor and determine if there is a sudden increase in activity (e.g., sound, movement, vibration, etc.) near the user. For example, the activity may be due to one or more passengers who may be agitated, drunk, running for help with an emergency, abandoning the travel vehicle, or the like. In one embodiment, an unexpected event may be a long or an unscheduled stop of the travel vehicle along the travel route. For example, a train or a bus may experience a technical difficulty which could cause a long stop at a predetermined station or an unscheduled stop along the travel route while waiting for resolution of the technical difficulty.

At step 507, the notification platform may cause or generate a notification, presenting one or more information items, or combination thereof in the user interface based on the one or more unexpected activities. In various embodiments, a notification platform or one or more applications 103 may cause one or more notifications which may include one or more audible, visual, or tactile elements for alerting a user about the one or more unexpected activities or events. In various embodiments, a type, duration, priority, or other elements of a generated notification may be based on one or more elements associated with the unexpected activity. For example, an emergency situation determined to exist in a user's environment may cause the notification platform to generate a combination of various persistent notifications so to alert the user as quickly as possible.

At step 509, the notification platform may identify one or more points of interest associated with a route from the origin point to the destination point. In one scenario, the notification platform or the applications 103 may utilize various databases, user preferences, user history, user profile, historical information, or the like for identifying one or more POIs along a travel route where one or more notifications may be generated and presented at the user device 101. In one example, information about services available at a POI may be utilized for identifying a POI along the travel route. In one example, the information about the one or more POIs may be determined from a carrier, a service provider, a user travel itinerary, or the like.

At step 511, the notification platform may cause a presentation of the one or more points of interest in the user interface, wherein the notification point is selected from among the one or more points of interest. In one embodiment, the notification platform or the applications 103 may present at a user device 101 the one or more POIs as recommended notification points along a travel route. In one embodiment, the one or more POIs may be presented based on one or more categories, priorities, listings, or the like, which may be determined by the notification platform, the applications 103, a service provider, or the like. In one embodiment, notification platform may determine an input from a user for selecting a POI as a notification point along the travel route. In one embodiment, the notification platform may receive an input from a user for further updating a list of POIs, narrowing the list to fewer POIs, or the like. In one embodiment, the notification platform may cause a selection of a POI as a notification point based on the user input and one or more other parameters determined by the notification platform. For example, a user may select a plurality of POIs and request that the notification platform select a POI based on a distance from the destination point, a particular service that may be available at a POI, or the like.

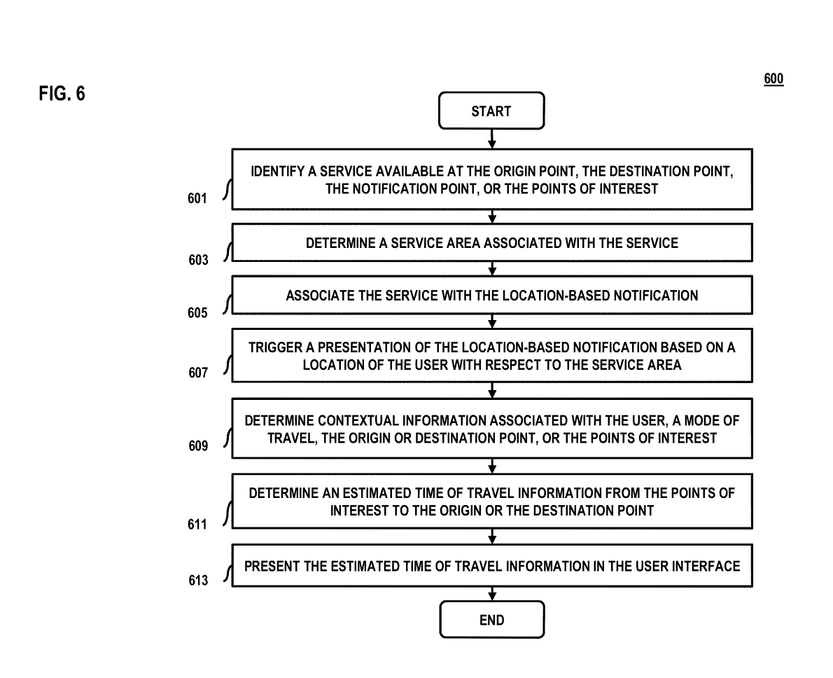

Referring to FIG. 6 now, the process 600 may begin at step 601 where the notification platform may identify a service available at the origin point, the destination point, the notification point, the one or more points of interest, or a combination thereof. In various embodiments, notification platform or the applications 103 may determine from one or more sources information about one or more services that may be available along a travel route. For example, the information may be available from a service provider, a carrier utilized by the user, various databases, a given POI (e.g., a bus station), or the like. In various scenarios, the information may be determined before commencement of or during a user travel. For example, once the notification platform determines a user travel plan (e.g., from a calendar application associated with the user, a travel itinerary of the user, etc.), it can determine one or more services that may be available at the origin point, at a notification point, at POIs along a travel route, at the destination point, or the like. In one scenario, notification platform may receive an input via a UI at a user device, wherein the input indicates a particular service of interest to the user.

At step 603, the notification platform may determine a service area associated with the service. In one embodiment, the notification platform or the applications 103 may determine a service area associated with a service that may be available at one or more locations along a travel route or a movement path. In one scenario, the service may be a personal service (e.g., health services) where the service area may be limited to a certain area. For example, certain procedures or services at a hospital may be limited to a certain area within the hospital or to patients who are within that area. In one scenario, a service available along a travel route may be limited to certain geo-locations along the travel path, at a certain POI, or the like, wherein the service area may also be limited at a given geo-location or a POI. For example, a communications service may be available at a certain POI, but the service may become limited or unavailable when the user is at a certain distance away from the POI.

At step 605, the notification platform may associate the service with the location-based notification. In one scenario, the notification platform or the applications 103 may associate a service available at a POI with a location-based notification that is to be generated and presented when the service is determined to be available. For example, the notification platform may determine a request from a user or a service provider to associate a certain service with a location-based notification.

At step 607, the notification platform may trigger a presentation of the location-based notification based on a location of the user with respect to the service area. In one embodiment, once a location-based notification is associated with an availability of a given service, a notification may be generated and presented once the availability of the service is detected by the notification platform, the applications 103, a service provider, or the like. For example, a location-based notification may be associated with certain radiology services at a hospital and once location of a patient/user is determined to be at an area where the service is available, then a location-based notification can be generated and presented at a user device 101 or one or more other user devices 101 associated with other users (e.g., hospital staff).

At step 609, the notification platform may determine contextual information associated with the user, a mode of travel employed by the user, the origin point, the destination point, the one or more points of interest, or a combination thereof, wherein the estimated time of travel information is further based on the contextual information. In various scenarios, the notification platform may determine contextual information by processing or analyzing information about the user profile, user preferences, user history, a mode of travel for a given travel route/plan, time of travel (e.g., during a day, a week, season, month, etc.), travelling speed, various POIs along the travel route, or the like. Further, location information of an origin point, a destination point, or other POIs along a travel route may be utilized in determining the contextual information. For example, the contextual information may take into consideration information that a user is travelling from a city center, by bus, during a rush-hour, via a route that is under construction, wherein the estimated time of travel information may take into account various delays or issues associated with the different information.

At step 611, the notification platform may determine an estimated time of travel information from the one or more points of interest to the origin point, the destination point, or a combination thereof. In one embodiment, the notification platform or the applications 103 may utilize location information associated with the one or more points of interest, the origin point, or the destination point to determine distance information or an estimated time of travel between any two points. Also, the notification platform or the applications 103 may utilize historical data for determining the estimated time of travel from one point to another. Additionally, the notification platform or the applications 103 may utilize current traffic or road/pathway condition information for determining the estimated time of travel information.

At step 613, the notification platform may cause a presentation of the estimated time of travel information in the user interface. In one scenario, the notification platform may utilize the estimated time of travel information and present that information along with one or more information items associated with a travel route, notification point, POIs along a travel route, or the like. In one example, the estimated time of travel information may be utilized to prioritize or categorize a plurality of recommended notification points, location-based notifications, or the like. In one embodiment, a UI may present one or more options for a user to interact with the recommended notification points, location-based notifications, or POIs based on the estimated time of travel information associated with the respective location points.

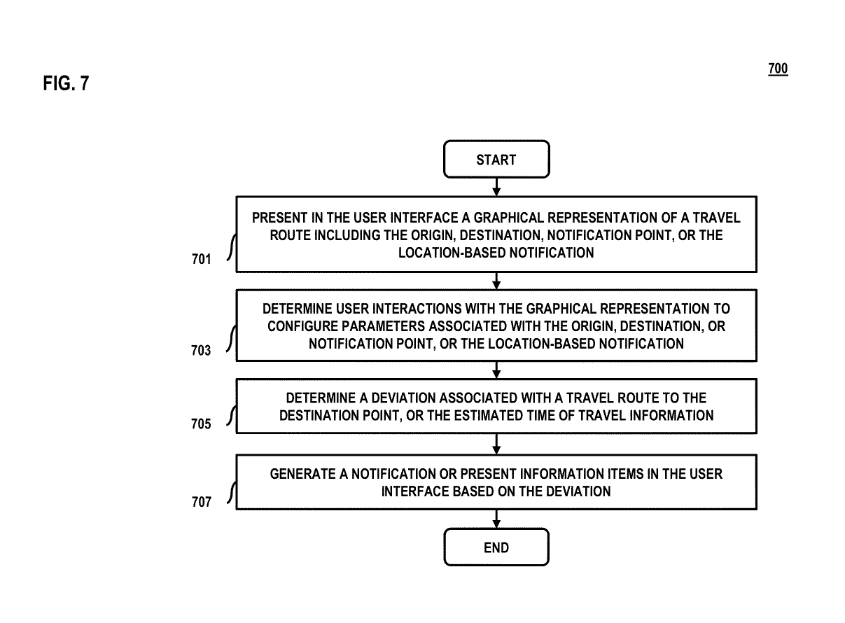

Referring to FIG. 7 now, the process 700 may begin at step 701 where the notification platform may cause a presentation in the UI a graphical representation of a travel route including the origin point, the destination point, the notification point, the location-based notification, or a combination thereof. In one embodiment, the notification application may present a map application including one or more information items associated with a travel route from an origin point to a destination point. As noted earlier, the travel information about the origin or destination points may be determined from a user input, a service provider, various applications at the user device 101, a travel itinerary, a user movement plan, or the like. For example, a travel plan may indicate that the user has started or will start travelling from a point “A” to a point “B.”

At step 703, the notification platform may determine one or more user interactions with the graphical representation to configure one or more parameters associated with the origin point, the destination point, the notification point, the location-based notification, or a combination thereof. In one scenario, a user may elect to interact with the presented map view for effectuating one or more changes to a presented route, destination/origin points, POIs, or other information or options presented via the UI. In one scenario, a user may select the option 807a for the notification application 107 to “Recommend A Notification Point” along the travel route 823. In one scenario, the notification application 107 may determine and recommend a notification point and then present that information in a UI element (e.g., message) where the user can either confirm/accept the recommended notification point or provide additional input for selecting another notification point or options. Additionally, the user may interact with the map application to select a different notification point, or request for additional information about the POIs or services that may be associated with one or more potential travel routes.

At step 705, the notification platform may determine a deviation associated with a travel route to the destination point, the estimated time of travel information, or a combination thereof. In various scenarios, the notification platform may utilize information available from the applications 103, a service provider, a carrier associated with a travel route, or the like for monitoring travel/movement progress along a travel route. Further, the monitoring information may be analyzed to determine any deviations associated with the travel route or the estimated time of travel information that was previously determined. In one example, a deviation may indicate a change in travel direction of the user, which may be due to a detour, a change in a planned route, or the like. Further, a deviation may be due to a potential change in the time of travel, which now may be earlier or later, for instance, due to traffic/route conditions.

At step 707, the notification platform may generate a notification, present one or more information items, or a combination thereof in the user interface based on the deviation. In various scenarios, the notification platform may generate a notification or present information via the UI at a user device, wherein the notification or the presented information may be based on the user activity (e.g., sleeping, playing games, using the user device, etc.), the kind of deviation, cause of the deviation, potential impact of the deviation on the travel schedule or on the user, or the like. For example, a deviation (e.g., a quick restroom stop) that may cause a delay of a few minutes may cause a short non-intrusive notification whereas a deviation that could potentially cause several hours of delay may cause urgent notifications or until the user interacts with (e.g., acknowledge) the presented notifications.

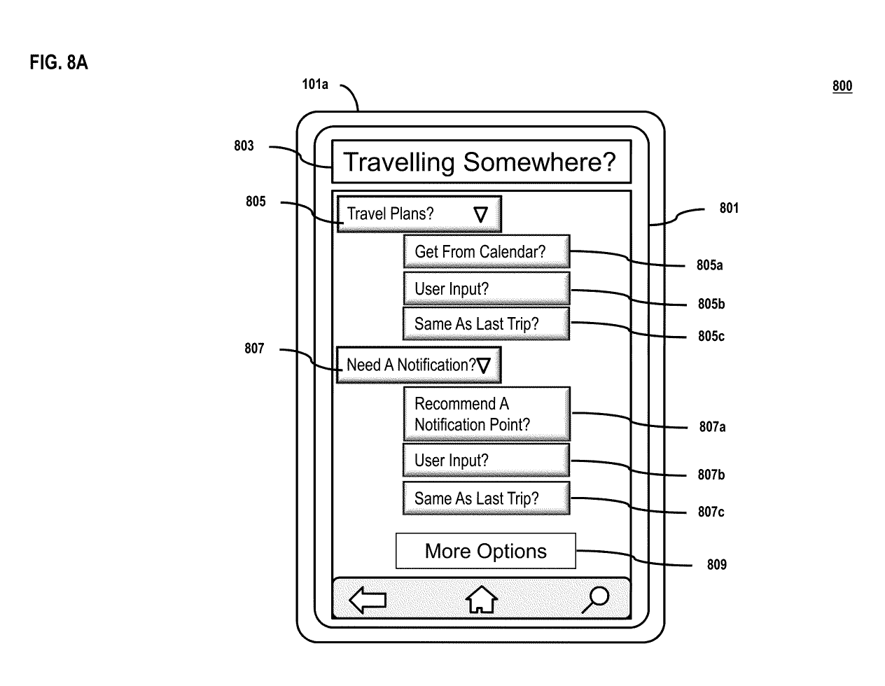

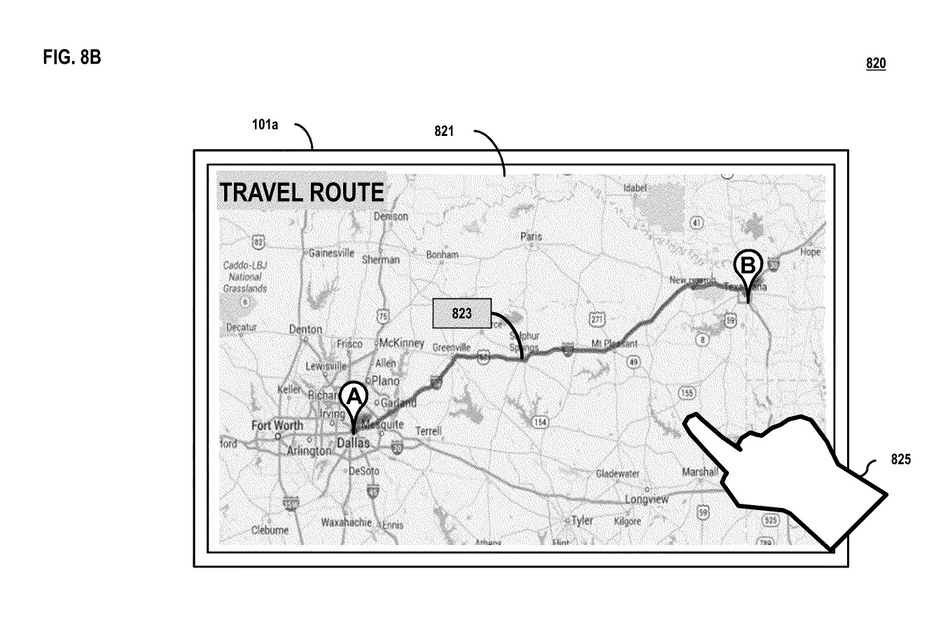

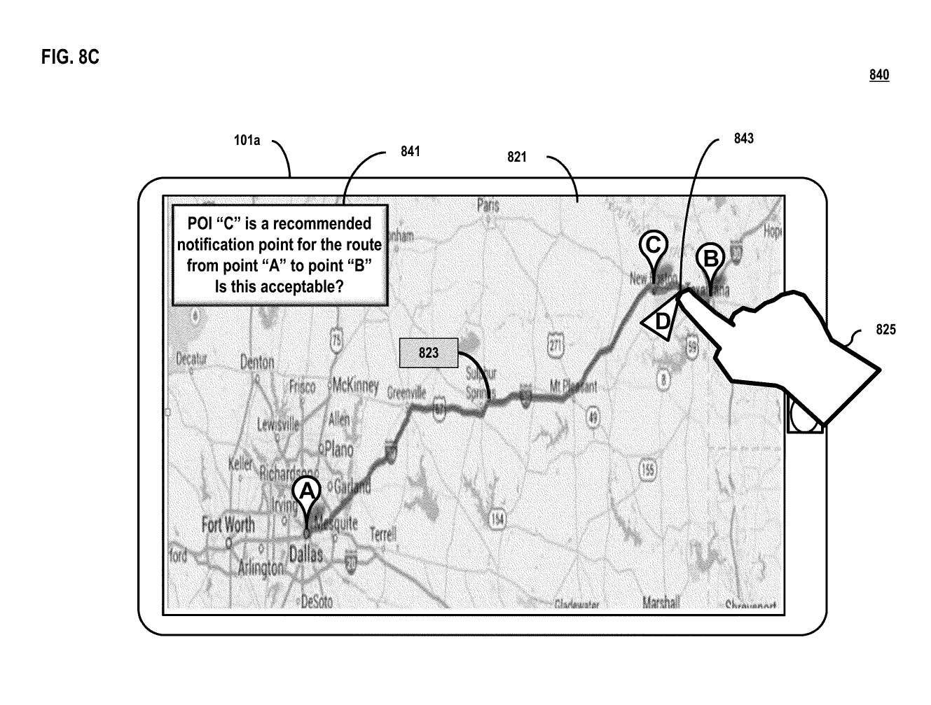

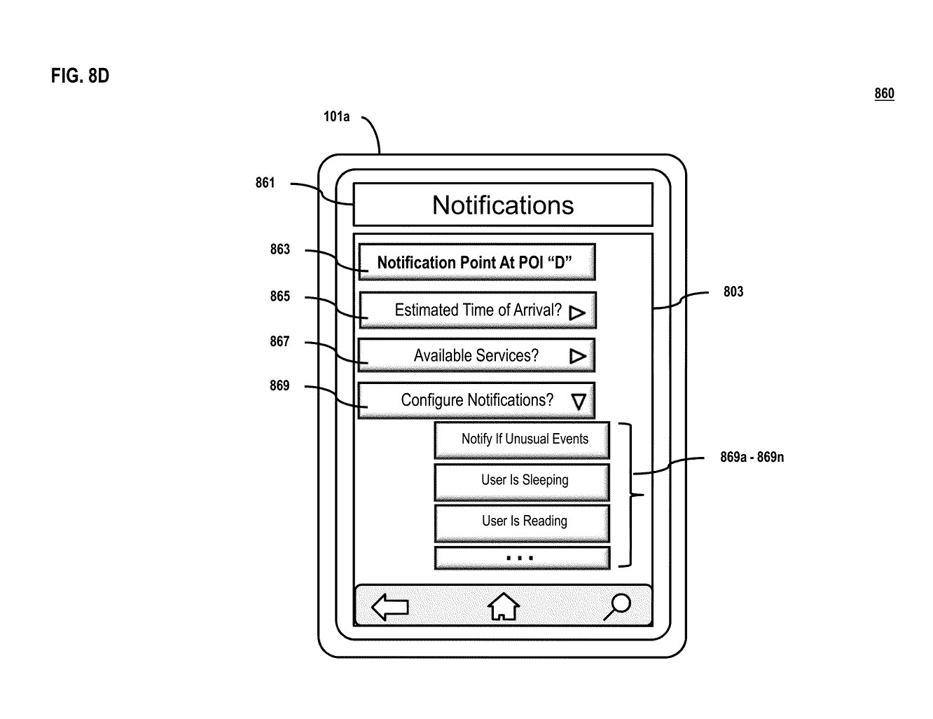

FIGS. 8A through 8D are diagrams of user interfaces for use in the processes of FIGS. 4 through 7, according to various embodiments.

FIG. 8A includes an illustration 800 of a UI 801 presented at a user device 101a. In various embodiments, the UI 801 may include various UI elements for a user interaction for determining one or more information items associated with a travel or a movement of the user from one geo-location to another geo-location. In one embodiment, the UI 801 may include UI elements associated with a travel notification application 803 (e.g., notification application 107) where it may present a query to a user of the user device 101a as to whether the user is planning to travel. In one example, the query may be based on location information of the user as being at a train or a bus station. In another scenario, a user may launch the application 803 at the user device 101a for inputting information about or for planning a travel. In one example, the application 803 may determine the information about an upcoming travel from one or more other applications at the user device 101, a travel itinerary at the user device 101, a service provider, or the like. In various embodiments, a user may select from one or more options 805a-805n in a prompt 805. For example, the user may select from options 805a for the application 803 to “Get From Calendar,” 805b for “User Input,” 805c for “Same As Last trip,” or the like. Further, the UI 801 may present a prompt 807 where a user may interact with and select from various options 807a-807n associated with a notification. For example, the user may confirm a request for a notification at 807 and then further interact with the option 807a to request for the application 803 to “Recommend A Notification Point,” or with the option 807b to indicate that the application 803 is to receive information via “User Input,” or with the option 807c to indicate that a notification for a current or an upcoming trip should be “Same As Last Trip.” Additionally, the user may request for “More Options” via the UI element 809.

FIG. 8B includes an illustration 820 of a UI presented at a user device 101a. In one embodiment, the notification application 107 may cause or may present a map application 821 including one or more information items associated with a travel route 823 from an origin point “A” to a destination point “B.” As noted earlier, the travel information about point “A” or “B” may be determined from a user input, a service provider, one or more applications at the user device 101, a travel itinerary, a user movement plan, or the like. For example, a travel plan may indicate that the user has started or will start travelling from the point “A” to the point “B.” In one embodiment, a movement of a user may be over a short distance in a campus (e.g., a hospital, a university, a shopping mall, a factory complex, etc.) In one scenario, a user 825 may elect to interact with the presented map view for effectuating one or more changes to the presented route 823, the points “A” and “B,” or other information or options presented via the UI.

FIG. 8C includes an illustration 840 of a UI presented at a user device 101a. In one scenario, a user may select the option 807a for the notification application 107 to “Recommend A Notification Point” along the travel route 823. In one scenario, the notification application 107 may determine and recommend a notification point “C” and present that information in a UI message 841 where the user 825 can confirm/accept the recommended notification point “C” or to provide additional input for selecting another notification point or another option. Additionally, the user 825 may interact with the map application 821 to indicate a different notification point 843, “D”. In various embodiments, the user 825 may interact with one or more POIs on the travel route 823 where the notification application 107 or the applications 103 may determine and present additional information about the POIs or the travel route 823. In one embodiment, the additional information may include information about one or more services associated with the POIs along the route 823.

FIG. 8D includes an illustration 860 of a UI presented at a user device 101a. In one scenario, the UI 803 may present UI element 861 “Notifications” associated with a travel route and a notification point thereon. In various embodiments, the UI 803 may further include a UI indicator 863 indicating that a notification point at POI “D” has been selected, for example, by the user of the user device 101. Further, the UI 803 may present additional options 865, 867, and 869. For instance, the UI option 865 may include one or more options for presenting information about an “Estimated Time of Arrival” that may be related to arrival time at a notification point, at a destination point, at one or more other POIs along a travel route, or the like. In one example, the UI option 867 may include options for determining or presenting information about “Available Services” at a notification point, at a destination point, at one or more other POIs along a travel route, or the like. Further, the UI option 869 may provide options 869a-869n for a user to “Configure Notifications” that are to be generated and presented at one or more notification points along a travel route. In various scenarios, the options 869a-869n may include an option for a user to select “Notify if Unusual Events,” or to indicate that the “User Is Sleeping,” or that the “User Is Reading,” or the like.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enables determining and providing contextual notifications and user interface at a user device. As an advantage, a notification application or a notification platform may be utilized to generate and present at a user device notifications and information associated with various POIs along a travel route or a movement path. Additionally, various options may be presented at the user device so that a user may interact with the notifications, a notification application 107, or a notification platform 108.

The processes described herein for facilitating a notification application or a notification platform may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

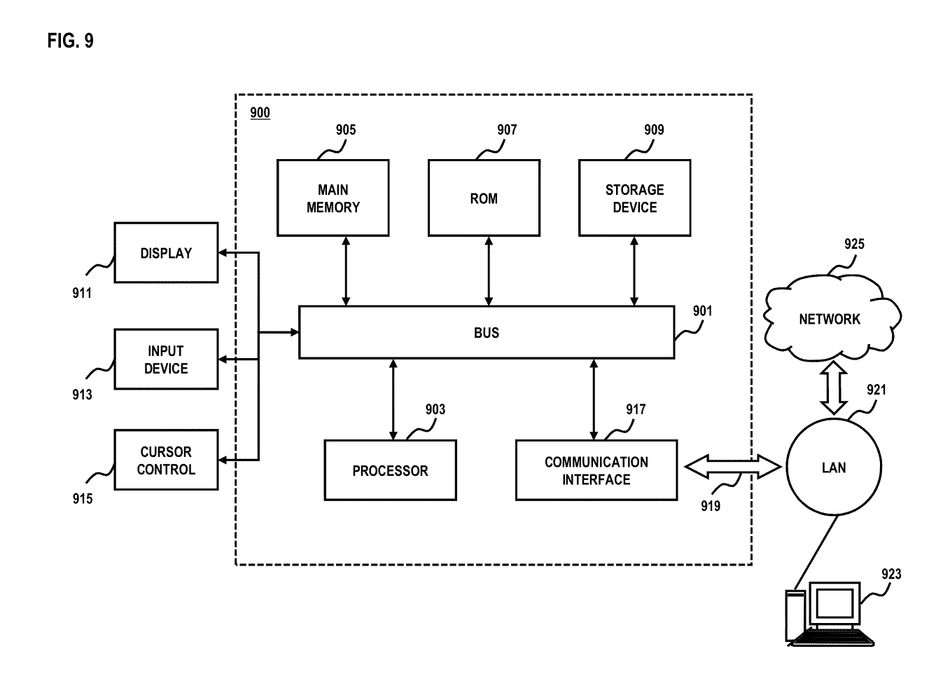

FIG. 9 illustrates computing hardware (e.g., computer system) upon which an embodiment according to the invention can be implemented. The computer system 900 includes a bus 901 or other communication mechanism for communicating information and a processor 903 coupled to the bus 901 for processing information. The computer system 900 also includes main memory 905, such as random access memory (RAM) or other dynamic storage device, coupled to the bus 901 for storing information and instructions to be executed by the processor 903. Main memory 905 also can be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multiprocessing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

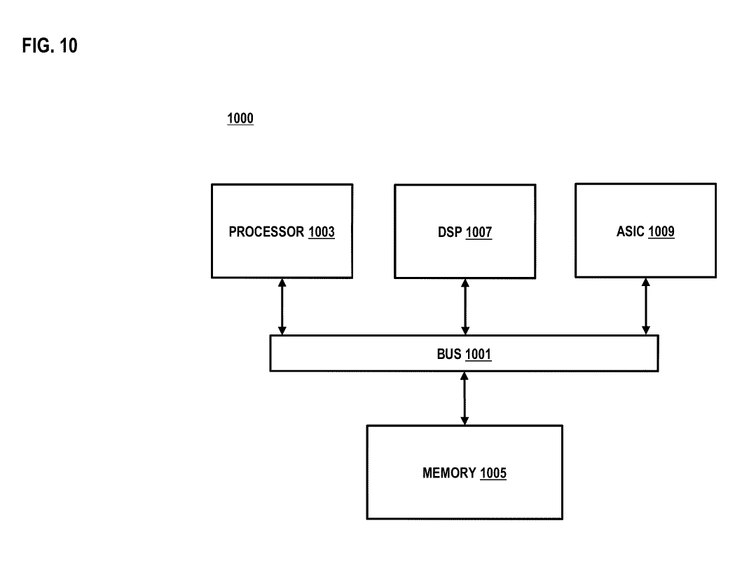

FIG. 10 illustrates a chip set 1000 upon which an embodiment of the invention may be implemented. Chip set 1000 is programmed to provide for determining and providing contextual notifications and user interface at a user device includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of processes in FIGS. 4 through 7.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting a user interface, wherein the user interface presents an origin point, a destination point, or a combination thereof associated with a user;
receiving an input via the user interface for specifying a notification point; and
generating a location-based notification based on the notification point,
wherein the location-based notification is triggered when the user is within a predetermined proximity of the notification point.

2. A method of claim 1, further comprising:
determining a recommended notification point based on contextual information, historical information, user preference information, or a combination thereof; and
presenting the recommended notification point in the user interface.

3. A method of claim 1, further comprising:
determining one or more unexpected activities in an environment associated with the user during a travel to the destination point; and
generating a notification, presenting one or more information items, or combination thereof in the user interface based on the one or more unexpected activities.

4. A method of claim 1, further comprising:
identifying one or more points of interest associated with a route from the origin point to the destination point; and
presenting the one or more points of interest in the user interface,
wherein the notification point is selected from among the one or more points of interest.

5. A method of claim 4, further comprising:
identifying a service available at the origin point, the destination point, the notification point, the one or more points of interest, or a combination thereof;
determining a service area associated with the service;
associating the service with the location-based notification; and
triggering a presentation of the location-based notification based on a location of the user with respect to the service area.

6. A method of claim 4, further comprising:
determining contextual information associated with the user, a mode of travel employed by the user, the origin point, the destination point, the one or more points of interest, or a combination thereof;
determining an estimated time of travel information from the one or more points of interest to the origin point, the destination point, or a combination thereof based on the contextual information; and
presenting the estimated time of travel information in the user interface.

7. A method of claim 6, further comprising:
determining a deviation associated with a travel route to the destination point, the estimated time of travel information, or a combination thereof; and
generating the location-based notification, presenting one or more information items, or a combination thereof in the user interface based on the deviation.

8. A method of claim 1, wherein the user interface comprises:
a first section to configure one or more parameters for a travel route, wherein the first section includes one or more options for selecting a source of information for the travel route,
a second section to configure one or more parameters for the location-based notification, wherein the second section includes one or more options for selecting the notification point, and
a third section to configure one or more options for including one or more information items in a presentation of the location-based notification.

9. A method of claim 1, further comprising:
presenting in the user interface a graphical representation of a travel route including the origin point, the destination point, the notification point, the location-based notification, or a combination thereof; and
determining one or more user interactions with the graphical representation to configure one or more parameters associated with the origin point, the destination point, the notification point, the location-based notification, or a combination thereof.

10. An apparatus comprising:
a processor; and
a memory including computer program code for one or more programs,
the memory and the computer program code configured to, with the processor, cause the apparatus to perform at least the following:
present a user interface, wherein the user interface presents an origin point, a destination point, or a combination thereof associated with a user;
receive an input via the user interface for specifying a notification point; and
generate a location-based notification based on the notification point,
wherein the location-based notification is triggered when the user is within a predetermined proximity of the notification point.

11. An apparatus of claim 10, wherein the apparatus is further caused to:
determine a recommended notification point based on contextual information, historical information, user preference information, or a combination thereof; and
present the recommended notification point in the user interface.

12. An apparatus of claim 10, wherein the apparatus is further caused to:
determine one or more unexpected activities in an environment associated with the user during a travel to the destination point; and
generate a notification, presenting one or more information items, or combination thereof in the user interface based on the one or more unexpected activities.

13. An apparatus of claim 10, wherein the apparatus is further caused to:
identify one or more points of interest associated with a route from the origin point to the destination point; and
present the one or more points of interest in the user interface,
wherein the notification point is selected from among the one or more points of interest.

14. An apparatus of claim 13, wherein the apparatus is further caused to:
identify a service available at the origin point, the destination point, the notification point, the one or more points of interest, or a combination thereof;
determine a service area associated with the service;
associate the service with the location-based notification; and
trigger a presentation of the location-based notification based on a location of the user with respect to the service area.

15. An apparatus of claim 13, wherein the apparatus is further caused to:
determine contextual information associated with the user, a mode of travel employed by the user, the origin point, the destination point, the one or more points of interest, or a combination thereof;
determine an estimated time of travel information from the one or more points of interest to the origin point, the destination point, or a combination thereof based on the contextual information; and
present the estimated time of travel information in the user interface.

16. An apparatus of claim 10, wherein the user interface comprises:
a first section to configure one or more parameters for a travel route, wherein the first section includes one or more options for selecting a source of information for the travel route,
a second section to configure one or more parameters for the location-based notification, wherein the second section includes one or more options for selecting the notification point, and
a third section to configure one or more options for including one or more information items in a presentation of the location-based notification.

17. An apparatus of claim 10, wherein the apparatus is further caused to:
present in the user interface a graphical representation of a travel route including the origin point, the destination point, the notification point, the location-based notification, or a combination thereof; and
determine one or more user interactions with the graphical representation to configure one or more parameters associated with the origin point, the destination point, the notification point, the location-based notification, or a combination thereof.

18. A system comprising:
a notification platform configured to cause a presentation of a user interface at a user device, wherein the user interface presents an origin point, a destination point, or a combination thereof associated with a user; receive an input via the user interface for specifying a notification point; and generate a location-based notification based on the notification point, wherein the location-based notification is triggered when the user is within a predetermined proximity of the notification point.

19. A system of claim 18, wherein the notification platform is further configured to:
determine a recommended notification point based on contextual information, historical information, user preference information, or a combination thereof; and
present the recommended notification point in the user interface.

20. A system of claim 18, wherein the notification platform is further configured to:
identify a service available at the origin point, the destination point, the notification point, one or more points of interest, or a combination thereof;
determine a service area associated with the service;
associate the service with the location-based notification; and
trigger a presentation of the location-based notification based on a location of the user with respect to the service area.
